(19) United States
(12) Patent Application Publication
(10) Pub. No.: US 2025/0215163 A1
(43) Pub. Date: Jul. 3, 2025

(54) HYDROSILYLATION CURABLE POLYETHER FORMULATIONS

(71) Applicant: Dow Silicones Corporation, Midland, MI (US)

(72) Inventors: Martin Grasmann, Midland, MI (US); Emmanuel Duquesne, Seneffe (BE); Bizhong Zhu, Midland, MI (US); Brian Harkness, Midland, MI (US)

(21) Appl. No.: 18/850,096

(22) PCT Filed: Jan. 18, 2023
(86) PCT No.: PCT/US2023/010994

§ 371 Date: Sep. 24, 2024

Related U.S. Application Data
(60) Provisional application No. 63/330,348, filed on Apr. 13, 2022.

(51) Int. Cl. C08G 77/46; C08G 77/00

(52) U.S. Cl. CPC C08G 77/46; C08G 77/80

(57) ABSTRACT

A composition containing: (a) a polyether with an average of 1.4 or more unsaturated carbon-carbon bonds per molecule; (b) one or more silyl-hydride functional polysiloxane crosslinker that is free of phenyl groups and that comprises 90 mole-percent or more of a combination of the following siloxane units: H(R³)₂SiO_{1/2}, SiO_{4/2} and optionally (R³)₃SiO_{1/2} where the average number per molecule of H(R³)₂SiO_{1/2} units is 2 or more, the average number per molecule of SiO_{4/2} units is one or more and the average number per molecule of (R³)₃SiO_{1/2} units is such that the number of (R³)₃SiO_{1/2} units divided by the sum of H(R³)₂SiO_{1/2} and (R³)₃SiO_{1/2} units is less than 0.7; where R³ is independently in each occurrence selected from hydrocarbyl groups having from one to 8 carbon atoms; and (c) a hydrosilylation catalyst; where the molar ratio of SiH/C═C in the composition is in a range of 0.3 to 10.

### FIELD OF THE INVENTION

The present invention relates to an addition reaction curable polyether composition that does not require phenyl-functionalized silicone crosslinkers as a compatibilizing crosslinker.

### INTRODUCTION

Silane modified polymers (SMPs) are a class of materials that consist of an organic polymer backbone terminated with silane groups. SMPs are useful in formulating adhesives and sealants, such as room temperature vulcanizable (RTV) sealants, utilizing the reactivity of the silane terminal groups for curing. Two types of currently available SMPs are silane terminated polyethers (STPE) and silane modified polyurethanes (STPU). Silane terminated polyethers tend to offer a lower modulus and better durability than silane terminated polyurethanes so they are often more desirable, particularly in sealant applications.

SMP compositions cure through polycondensation so they require moisture to cure. Typically, polycondensation curing of SMP compositions utilizes atmospheric moisture to cure. That means there must be atmospheric moisture present to achieve curing. Additionally, it means that moisture must penetrate into the SMP composition to effect a thorough cure. As a result, cure rates of SMP compositions are dependent on the available moisture and the rate at which that moisture can penetrate into the SMP material. When atmospheric moisture is low (such as arid geographies) curing is difficult to achieve. Even when atmospheric moisture is present, moisture penetration is typically slow into SMP materials so thorough curing can take anywhere from hours to days to achieve. Penetration of moisture becomes even more of a problem when the SMP-based formulations are located in a position that requires atmospheric moisture to go through a long diffusion path to even reach the formulation. An additional drawback to polycondensation curing SMP compositions is that they produce volatile organic compounds (VOCs) such as methanol as they cure.

It is desirable to discover alternatives to currently available SMP compositions that cure by a mechanism other than polycondensation to avoid the need for moisture and the production of VOC by-products. In particular, it is desirable to identify addition-cure silane modified polyether compositions that cure by a mechanism other than polycondensation. One alternative option is to cure using addition cure chemistry such as hydrosilylation. A challenge with hydrosilylation chemistry for polyether compositions is achieving compatibility with polyether components and silicone crosslinker components, both of which are in the composition, so that they are miscible. This challenge has been addressed in prior art by incorporating phenyl groups on the silicone crosslinking agent to increase compatibility. However, phenyl-containing silicone materials are expensive due to the complexity of manufacturing them. Therefore, it is desirable to identify an addition reaction curable polyether composition that does not require phenyl-functionalized silicone crosslinkers yet that has components that are compatible with one another and that cures at 80 degrees Celsius (° C.) within 90 minutes and preferably within 24 hours at 25° C.

### BRIEF SUMMARY OF THE INVENTION

The present invention provides an addition reaction curable polyether composition that does not require phenyl-functionalized silicone crosslinkers yet that has components that are compatible with one another. The addition reaction curable polyether composition can cure at 80 degrees Celsius (° C.) within 90 minutes and in some cases can cure within 24 hours at 25° C. In fact, the entire composition can be free from phenyl-functionalized silicone crosslinkers, and can even be free of phenyl-functionalized components altogether.

The present invention is a result of discovering that silyl hydride functional silicone resins that, relative to all siloxane units in the resin, comprises 90 mole-percent (mol %) or more and can comprise 95 mol % or more, even 99 mol % or more, even 100 mol % of a combination of SiO_{4/2}, H(R¹)₂SiO_{1/2} and optionally (R¹)₃SiO_{1/2} siloxane units, with mol % relative to total siloxane units and preferably all copolymerized units in the SiH functional polysiloxane, are compatible with alkenyl functional polyethers and suitable crosslinkers in phenyl-free silane modified polyether compositions that cure by addition chemistry rather than polycondensation.

In a first aspect, the present invention is an addition reaction curable polyether composition comprising: (a) a polyether with an average of 1.4 or more unsaturated carbon-carbon bonds per molecule; (b) one or a combination of more than one silyl-hydride functional polysiloxane crosslinker that is free of phenyl groups and that comprises 90 mole-percent or more of a combination of the following siloxane units: H(R³)₂SiO_{1/2}, SiO_{4/2} and optionally (R³)₃SiO_{1/2} where the average number per molecule of H(R³)₂SiO_{1/2}, units is 2 or more, the average number per molecule of SiO_{4/2} units is one or more and the average number per molecule of (R³)₃SiO_{1/2} units is such that the number of (R³)₃SiO_{1/2} units divided by the sum of H(R³)₂SiO_{1/2} and (R³)₃SiO_{1/2} units is less than 0.7; where R³ is independently in each occurrence selected from hydrocarbyl groups having from one to 8 carbon atoms; and (c) a hydrosilylation catalyst; where the molar ratio of SiH/C═C in the addition reaction curable polyether composition is in a range of 0.3 to 10.

In a second aspect, the present invention is a process for using the addition reaction curable polyether composition of the previous aspect, the process comprising disposing the addition reaction curable polyether composition onto another material and then curing the addition reaction curable polyether composition by heating to 80 degrees Celsius or higher.

The addition reaction curable polyether composition of the present invention is useful as a composition that can be used, for example, as a sealant or adhesive.

### DETAILED DESCRIPTION OF THE INVENTION

Test methods refer to the most recent test method as of the priority date of this document when a date is not indicated with the test method number. References to test methods contain both a reference to the testing society and the test method number. The following test method abbreviations and identifiers apply herein: ASTM refers to American Society for Testing and Materials; EN refers to European Norm; DIN refers to Deutsches Institut für Normung; and ISO refers to International Organization for Standards.

“Multiple” means two or more. “And/or” means “and, or as an alternative”. All ranges include endpoints unless otherwise indicated.

Chemical structures herein indicate propylene oxide units as [OCH₂CH(CH₃)], but is it to be understood and is intended that the chemical structure are not limited to that orientation of the propylene oxide. For instance, the propylene oxide units can be [OCH₂CH(CH₃)], [OCH(CH₃)CH₂], or a combination of the two orientations.

Siloxane units can be characterized by the designation M, D, T or Q. M refers to a siloxane unit having the formula “(CH₃)₃SiO_{1/2}”. D refers to a siloxane unit having the formula “(CH₃)₂SiO_{2/2}”. T refers to a siloxane unit having the formula “(CH₃)SiO_{3/2}”. Q refers to a siloxane unit having the formula “SiO_{4/2}”. Non-oxygen groups bound to the silicon atom in M, D and T units are methyl groups unless otherwise stated or indicated. Notably, an oxygen atom having a multiple of “½” subscript indicates that the oxygen bridges the specified atom to a second atom where the second atom is also specified with an oxygen having a multiple of “½” subscript. For example, ((CH₃)₃SiO_{1/2}) (SiO_{4/2}), or MQ, refers to a M unit bound to a Q unit with an oxygen atom shared between the silicon atom of the M unit and a silicon atom o the Q unit. The multiplier of the ½ subscript indicates how many oxygen atoms are in such a shared bonding configuration with the silicon atom of the siloxane unit.

Reference to a siloxane unit designation with the suffix “-type” refers to the siloxane unit where any one or more than one methyl group is actually an R group where R is a group other than methyl such as hydroxyl, alkoxyl, or hydrocarbyl. The hydrocarbyl typically contains from one to 8 carbon atoms. For instance, R can be methyl, ethyl, propyl, butyl, pentyl, hexyl, heptyl, or octyl.

A siloxane unit can include as a superscript an indication of a group bound to that silicon atom in place of an alkyl group. For instance, “M^{H}-type” unit refers to an M-type unit with one R group replaced with hydrogen: ((R¹)₂HSiO_{1/2}). “M^{H}” unit refers to an M unit with one methyl replaced with a hydrogen atom ((CH₃)₂HSiO_{1/2}). T^{Ph} unit refers to a T unit with the methyl replaced with a phenyl group.

Chemical formula designations for polysiloxanes using M,D,T,Q abbreviations typically have subscripts associated with the unit designator that can either refer to the average mole ratio of that siloxane unit relative to all siloxane units in the molecule or the average number of the associate siloxane units in the molecule. When the subscript associated with a siloxane unit is greater than or equal to one, then the subscript refers to the average number of those siloxane units in the molecule. When the subscript associated with a siloxane unit is less than one then the subscript refers to the average mole ratio of that siloxane unit relative to the number of moles of all siloxane units in the molecule. An absence of a subscript implies a subscript value of one.

The addition reaction curable polyether composition of the present invention comprises a polyether having unsaturated carbon-carbon bonds, preferably in the form of allyl and/or methallyl functional groups. The polyether can be linear or branched, or be a combination of linear and branched polyethers. The polyether can be free of phenyl groups. The polyether has an average of 1.4 or more, preferably 1.6 or more, 1.7 or more, even 1.8 or more, and can have an average of 2.0 or more unsaturated carbon-carbon bonds per molecule while at the same time typically has an average of 5 or fewer, 4 or fewer, 3 or fewer, even 2 or fewer unsaturated carbon-carbon bonds per molecule. Typically, the unsaturated carbon-carbon bonds are carbon-carbon double bonds (C═C).

The polyether is not particularly limited, and various polyethers can be used. Typical examples thereof include polyethers having a main chain of recurring (—R¹—O—) units, where —R¹— represents a bivalent alkylene group. The polyether may have one kind of recurring unit or multiple kinds of recurring units, that is, R¹ may be the same or different in recurring units. The polyether may be a linear polymer or a branched polymer. The polyether can, and typically does, contain a small amount of other units that may or may not be reoccurring along the polymer chain. The other units can be from initiator used to synthesize the polymer for instance. Initiators can be any chemical species that can be catalyzed to polymerize polyether precursors. Examples of suitable initiators include glycerol and 1,4-butane diol.

The main chain of the polyether is favorably polyoxypropylene (that is, —R¹— above is —CH₂CH(CH₃)—). Polyethers having polyoxypropylene as the main chain are favorable from the points of commercial availability and processability. All of the regions of the polyether other than those of unsaturated carbon-carbon bond groups preferably have polyoxyalkylene skeletons, but the region may contain other structural units too. In such a case, the total amount of the polyether skeleton in the polymer is preferably 80 wt % or more, more preferably 90 wt % or more relative to weight of the polyether. The number-average molecular weight of the polyether is preferably 3000 or more, even 5000 or more while at the same time is typically 50000 or less, preferably 40000 or less, from the points of processability at room temperature and adhesive properties. A polyether having a number-average molecular weight of less than 3000 often gives a cured product that is more brittle, while a polyether having a number-average molecular weight of more than 50000 is more viscous, leading to deterioration in processability. The addition reaction curable polyether composition can comprise a combination of polyethers having different molecular weights, which can be desirable when properties of a broad molecular weight distribution are needed or desired. The molecular weight above is the number-average molecular weight as polystyrene that is determined by gel permeation chromatography (GPC). The bond of the unsaturated carbon-carbon double bond group to the polyether is not particularly limited, and examples thereof include direct bond of alkenyl group ether, ester bond, carbonate bond, urethane bond, urea bond, and the like.

The polyether can, for example, be a linear or branched allyl or a methallyl capped polypropylene oxide or a combination thereof. Desirably, the polymer is selected from any one or any combination of more than one of the following three exemplary polyethers:

First, a tri-branched polypropylene oxide having an average chemical structure (I):

(H₂C═CHCH₂—[OCH₂CH(CH₃)]ₘ—O)₃—R² (I)

where:
the value of m is the average number of propylene oxide units in a given polyether segment and can be the same or different for each of the three polyether segments provided that the value for m is greater than zero in each of the three segments and the average value of the sum of all three m values is 60 or more, 80 or more, 100 or more, 125 or more, 150 or more, 200 or more, 250 or more, 300 or more, 350 or more, 375 or more, 385 or more, even 400 or more, while at the same time 1000 or less, 750 or less, 700 or less, 600 or less, 500 or less, 400 or less, or even 385 or less or less; and
R² is a trivalent hydrocarbyl group, meaning it is a hydrocarbyl group with the three polyether chains attached thereto. For example, R² can have the chemical structure —CH(CH₂—)— with a polyether chain attached at each “-”.

Second, a diallyl end-capped polypropylene oxide having an average chemical structure (II):

{CH₂═CHCH₂O—[CH₂CH(CH₃)O]ₙ}₂—R⁴ (II)
where R⁴ is a divalent hydrocarbyl preferably containing one or more and can contain 2 or more 3 or more 4 or more, 5 or more, 6 or more, 7 or more, even 8 or more while at the same time typically contains 10 or fewer, 9 or fewer, 8 or fewer, 7 or fewer, 6 or fewer, 5 or fewer, 4 or fewer, even 3 or fewer carbon atoms; and subscript n is the average number of propylene oxide units in each of the two polypropylene oxide groups extending off from R⁴ and can independently in each occurrence have an average value of 10 or more, 20 or more, 50 or more, 60 or more, 75 or more, 100 or more, even 125 or more while at the same time typically has an average value of 1600 or less, 1400 or less, 1200 or less, 1000 or less, 750 or less, 500 or less, 250 or less, 200 or less, and can have an average value of 175 or less, 150 or less, 100 or less, 75 or less, 70 or less, even 65 or less. One particularly desirable R⁴ divalent hydrocarbyl is: —CH(CH₃)CH₂—.

Third, a di-methallyl end-capped polypropylene oxide having an average chemical structure (III):

{CH₂═C(CH₃)CH₂O—[CH₂CH(CH₃)O]ₒ}₂—R⁴ (III)
where R⁴ is a divalent hydrocarbyl preferably containing one or more and can contain 2 or more 3 or more 4 or more, 5 or more, 6 or more, 7 or more, even 8 or more while at the same time typically contains 10 or fewer, 9 or fewer, 8 or fewer, 7 or fewer, 6 or fewer, 5 or fewer, 4 or fewer, even 3 or fewer carbon atoms; and subscript o is the average number of propylene oxide units in each of the two polypropylene oxide groups extending off from R⁴ and can independently in each occurrence have an average value of 10 or more, 20 or more, 50 or more, 60 or more, 65 or more, 75 or more, 100 or more, even 125 or more while at the same time typically has an average value of 1600 or less, 1400 or less, 1200 or less, 1000 or less, 750 or less, 500 or less, 250 or less, 200 or less, and can have an average value of 175 or less, 150 or less, 100 or less, 75 or less, even 70 or less. One particularly desirable R⁴ divalent hydrocarbyl is: —CH(CH₃)CH₂—.

The addition reaction curable polyether composition also comprises one or a combination of more than one silyl-hydride (SiH) functional polysiloxane crosslinkers. Notably, the SiH functional polysiloxane crosslinkers are free of phenyl groups.

The SiH functional polysiloxane crosslinkers comprise 90 mole-percent (mol %) or more and can comprise 95 mol % or more, even 99 mol % or more, even 100 mol % of a combination of the following siloxane units, with mol % relative to total siloxane units and preferably all copolymerized units in the SiH functional polysiloxane crosslinker: SiO_{4/2}, H(R³)₂SiO_{1/2} and optionally (R³)₃SiO_{1/2}. Each R³ is independently in each occurrence selected from hydrocarbyl groups having one or more and can have 2 or more, 3 or more, 4 or more, 5 or more, 6 or more, even 7 or more while at the same time typically has 8 or fewer, 7 or fewer, 6 or fewer, 5 or fewer, 4 or fewer, 3 or fewer, or even 2 or fewer carbon atoms. Each R³ can be the same or there can be different R³ groups in the same molecule. Desirably, each R³ is a methyl group.

Generally, the SiH functional polysiloxane crosslinker contains on average one or more, 2 or more, 3 or more, 4 or more, 5 or more, 6 or more, 10 or more 15 or more, even 20 or more while at the same time typically 40 or fewer, 30 or fewer, 25 or fewer, 20 or fewer, even 15 or fewer SiO_{4/2} siloxane units per molecule.

Generally, the SiH functional polysiloxane crosslinker contains on average 2 or more and can contain 3 or more, 4 or more, 5 or more, 6 or more, 10 or more, 15 or more, even 20 or more while at the same time typically contains 40 or fewer and can contain 30 or fewer, 25 or fewer, 20 or fewer, 15 or fewer, 10 or fewer, 8 or fewer, 7 or fewer, 6 or fewer, even 5 or fewer H(R³)₂SiO_{1/2} units per molecule.

Generally, the SiH functional polysiloxane crosslinker contains on average zero or more, one or more and can contain 2 or more, 3 or more, 4 or more, 5 or more, 6 or more, 10 or more, even 20 or more while at the same time typically contains 30 or fewer and can contain 20 or fewer, 15 or fewer, 10 or fewer, 8 or fewer, 7 or fewer, 6 or fewer, even 5 or fewer (R³)₃SiO_{1/2} units per molecule provided that the average number per molecule of (R³)₃SiO_{1/2} units is such that the number of (R³)₃SiO_{1/2} units divided by the sum of H(R³)₂SiO_{1/2} and (R³)₃SiO_{1/2} units is less than 0.7, and can be 0.6 or less, 0.5 or less, 0.4 or less, 0.3 or less, 0.2 or less, 0.1 or less, or even zero.

Siloxane “resins” contain T-type and Q-type siloxane units and typically contain non-fully condensed Q-type, T-type and sometimes D-type siloxane units with “—OZ” groups where Z is selected from H or an alkyl group having one or more, or two or more and at the same time 8 or fewer, typically 6 or fewer carbon atoms. Generally, the concentration of —OZ groups in a siloxane resin is 5 mole-percent (mol %) or less based on moles of siloxane units in the resin. Herein, “resins” are presumed to contain up to 5 mol % based on moles of siloxane units in the resin even if the —OZ component is not specified in a formula for the resin.

The relative concentration of the polyether having allyl and/or methallyl functional groups and the SiH functional polysiloxane crosslinkers is such that the molar ratio of SiH/C═C bonds in the addition reaction curable polyether composition is 0.3 or more, preferably 0.4 or more, and can be 0.5 or more, 0.6 or more, 0.7 or more, 0.8 or more, 0.9 or more, one or more, even 1.5 or more while at the same time is desirably 10 or less, preferably 9 or less, 8 or less, 7 or less, 6 or less, even 5 or less, 4 or less, or even 3 or less.

The addition reaction curable polyether composition further comprises a hydrosilylation catalyst. Typically, the hydrosilylation catalyst is a platinum-based hydrosilylation catalyst. Platinum-based hydrosilylation catalysts include compounds and complexes such as platinum (0)-1,3-divinyl-1,1,3,3-tetramethyldisiloxane (Karstedt's catalyst), platinum-carbonyl complexes, platinum cyclovinylmethylsiloxane complexes, platinum acetylacetonate (acac), cyclopentadienyl alky platinum, platinum black, platinum compounds such as chloroplatinic acid, chloroplatinic acid hexahydrate, a reaction product of chloroplatinic acid and a monohydric alcohol, platinum bis(ethylacetoacetate), platinum bis(acetylacetonate), platinum dichloride, and complexes of the platinum compounds with olefins or low molecular weight organopolysiloxanes or platinum compounds microencapsulated in a matrix or core-shell type structure. The catalyst can be a supported Pt catalysts with Pt metal particles or compounds adsorbed onto or absorbed into a support material such as carbon or alumina. The hydrosilylation catalyst can be part of a solution that includes complexes of platinum with low molecular weight organopolysiloxanes that include 1,3-diethenyl-1,1,3,3-tetramethyldisiloxane complexes with platinum. These complexes may be microencapsulated in a resin matrix. Other transition or noble metal compounds can also be used as hydrosilylation catalysts, for example, di-μ.-carbonyl di-.π.-cyclopentadienyl dinickel.

The addition reaction curable polyether composition can further comprise, or be free of, a chain extender component that contains an average of two SiH groups per molecule and that is free of SiO_{4/2} siloxane units. The chain extender can comprise or be free of phenyl groups. As an example, the chain extender can have an average chemical composition: HR³₂SiOPh₂SiOSiR³₂H where “Ph” refers to a phenyl group and R³ is as defined above, and is preferably methyl. The concentration of chain extender is typically 2 wt % or less, and can be 1.8 wt % or less, 1.6 wt % or less, 1.4 wt % or less, 1.2 wt % or less, 1.0 wt % or less, 0.8 wt % or less, 0.6 wt % or less, 0.3 wt % or less, 0.1 wt % or less or even 0 wt % of the addition reaction curable polyether composition weight.

The addition reaction curable polyether composition can further comprise, or be free of, a hydrosilylation catalyst inhibitor. Examples of suitable hydrosilylation catalyst inhibitors include any one or any combination of more than one of acetylene-type compounds such as 2-methyl-3-butyn-2-ol; 3-methyl-1-butyn-3-ol; 3,5-dimethyl-1-hexyn-3-ol; 2-phenyl-3-butyn-2-ol;3-phenyl-1-butyn-3-ol; 1-ethynyl-1-cyclohexanol; 1,1-dimethyl-2-propynyl)oxy)trimethylsilane; and methyl(tris(1,1-dimethyl-2-propynyloxy))silane; ene-yne compounds such as 3-methyl-3-penten-1-yne and 3,5-dimethyl-3-hexen-1-yne; triazols such as benzotriazole; hydrazine-based compounds; phosphines-based compounds; mercaptane-based compounds; cycloalkenylsiloxanes including methylvinylcyclosiloxanes such as 1,3,5,7-tetramethyl-1,3,5,7-tetravinyl cyclotetrasiloxane and 1,3,5,7-tetramethyl-1,3,5,7-tetrahexenyl cyclotetrasiloxane.

The concentration of hydrosilylation catalyst inhibitor as a mole-ratio relative to platinum from the catalyst can be zero or more, 0.5 or more, 1.0 or more, 5.0 or more, 10 or more, 20 or more, 30 or more, 40 or more, 50 or more, even 100 or more while at the same time is typically 200 or less, 100 or less, 50 or less, 40 or less, 30 or less, 20 or less, 10 or less, 5 or less, and can be 1.0 or less.

The addition reaction curable polyether composition can further comprise, or be free of, an “additional” SiH functional crosslinker containing an average of 2 or more, preferably 3 or more SiH functional groups per molecule where the additional SiH functional crosslinker does not meet the qualification of the SiH functional polysiloxane crosslinker described hereinabove. The additional SiH functional crosslinker can contain Ph groups or be free of Ph groups. Additionally, the SiH functional crosslinker can comprise SiO_{4/2} siloxane units or be free of SiO_{4/2} siloxane units.

The addition reaction curable polyether composition can be free of SiH functional polysiloxane having phenyl functionality. The SiH functional crosslinker can be cyclic or non-cyclic. The additional SiH functional crosslinker can also be non-cyclic. The addition reaction curable polyether composition can be free of cyclic SiH functional crosslinkers.

The present invention further includes a process for using the addition reaction curable polyether composition. The process comprises disposing the addition reaction curable polyether composition onto another material, a substrate for example, and then curing the addition reaction curable polyether composition by heating it, preferably to a temperature of 80 degrees Celsius (° C.) or higher.

### EXAMPLES

Table 1 identifies components used in the following examples. Me refers to methyl and Ph refers to phenyl.

TABLE 1

| Component | Description | Source |
|---|---|---|
| Polyether 1 | A polyether having an average chemical | Material available from |
| | structure: {H₂C═CHCH₂-[OCH₂ CH(CH₃)]ₘ- | HuangMa under product |
| | OCH₂}₂-CH-O-[CH(CH₃)CH₂O]ₚ-CH₂CH═CH₂ | name HMS-752M. |
| | where the sum of each m and p has an average | |
| | value of 385. | |
| Polyether 2 | A polyether having an average chemical | Available from NOF under |
| | structure: CH₂═CHCH₂O-[CH₂CH(CH₃)O]₆₃- | the name UNISAFE PKA- |
| | CH(CH₃)CH₂-[O(CH₃)CHCH₂]₆₃- | 5230. |
| | OCH₂CH═CH₂. | |
| Polyether 3 | CH₂═C(CH₃)CH₂O-[CH₂CH(CH₃)O]₆₈- | Prepare according to |
| | CH(CH₃)CH₂-[O(CH₃)CHCH₂]₆₈- | teaching in U.S. Pat. No. 8,901,255 |
| | OCH₂C(CH₃)═CH₂. | Example 1 except use |
| | | methallyl chloride instead of |
| | | allyl chloride. |
| SiH Crosslinker | Average chemical structure: | Available from The Dow |
| 1 | Me₃SiO-[HMeSiO]_{3.7}-[Me₂SiO]_{8.7}-SiMe₃ | Chemical Company as |
| | | DOWSIL ™ 1-3502 |
| | | Polymer. |
| SiH Crosslinker | Average chemical structure: | Available from The Dow |
| 2 | Me₃SiO-[HMeSiO]₅₆-[Me₂SiO]₃₄-SiMe₃ | Chemical Company as SYL- |
| | | OFF ™ 12-7672 Crosslinker. |
| SiH Crosslinker | Average chemical structure: | Available from The Dow |
| 3 | Me₃SiO-[HMeSiO]₅₀-SiMe₃ | Chemical Company as |
| | | DOWSIL ™ MH1107 Fluid |
| | | 20 cSt. |
| SiH Crosslinker | 45-50% methylhydrosiloxane- | Available from Gelest as |
| 4 | phenylmethylsiloxane copolymer hydride | HPM 502. |
| | terminated, 75-110 centiStoke (cSt), average | |
| | chemical formula: | |
| | [HMe₂SiO_{1/2}]₂[PhMeSiO_{2/2}]₂₀[HMeSiO_{2/2}]₁₅ | |
| SiH Crosslinker | Methyltris(dimethylsiloxy)silane. Average | Available from Gelest. |
| 5 | chemical structure: [HMe₂SiO]₃MeSi | |
| SiH Crosslinker | Phenyltris(dimethylsiloxy)silane. Average | Available from ABCR |
| 6 | chemical structure: [HMe₂SiO]₃PhSi | |
| SiH Crosslinker | Average chemical formula: | Prepare as described in |
| 7 | [HMe₂SiO_{1/2}]₆[PhSiO_{3/2}]₄ with up to 5 mol % | U.S. Pat. No. 7,625,986. |
| | Ph(OZ)SiO_{2/2} where Z is selected from hydrogen | |
| | and alkyl groups having 1 to 8 carbon atoms. | |
| SiH Crosslinker | Average chemical formula: | Prepare as described in |
| 8 | [.HMe₂SiO_{1/2}]_{9.83}[SiO_{4/2}]_{5.65} with up to 5 mol % of | U.S. Pat. No. 3,884,866. |
| | incompletely condensed Q component generally | |
| | represented by (OZ)ₐSiO₍₄₋ₐ₎₂ where subscript a is | |
| | 1 or 2 and Z is selected from hydrogen and alkyl | |
| | groups having 1 to 8 carbon atoms. | |
| SiH Crosslinker | Average chemical formula: | Prepare as described in |
| 9 | [HMe₂SiO_{1/2}]_{3.22}[Me₃SiO_{1/2}]_{4.98}[SiO_{4/2}]_{5.72} with up | U.S. Pat. No. 4,774,310. |
| | to 5 mol % of incompletely condensed Q | |
| | component generally represented by (OZ)ₐSiO_{(4-a)/2} | |
| | where subscript a is 1 or 2 and Z is selected | |
| | from hydrogen and alkyl groups having 1 to 8 | |
| | carbon atoms. | |
| Chain Extender | 1,1,5,5-tetramethyl-3,3-diphenyltrisiloxane, | Available from TCI as |
| 1 | having an average chemical | product number T3832. |
| | structure: [HMe₂SiO]₂Ph₂Si | |
| Hydrosilylation | Platinum (0)-1.3-divinyl-1,1,3,3-tetra, | Available from Sigma- |
| Catalyst 1 | ethyldisiloxane | Aldrich (CAS#68478-92-2) |

DOWSIL is a trademark of The Dow Chemical Company. SYL-OFF is a trademark of Dow Silicones Corporation.

### Preparation of Sample Compositions

Components for the sample compositions are in the tables below. Dry the polyether component under vacuum at 110 degrees Celsius (° C.) for 12 hours and store in a glovebox. Combine the polyether with the catalyst component inside a glovebox using a Flacktec SpeedMixer™ (Flacktek SpeedMixer is a trademark of Flacktec, Inc.) at 2500 revolutions per minute (RPM) for 30 seconds. Add the SiH Crosslinker component while inside the glovebox and mix using a Flacktek SpeedMixer™ at 2500 RPM for 30 seconds.

Cure the samples in open cups at 80° C. for 30 minutes or 90 minutes as indicated in the tables below.

### Characterization of Sample Compositions

Compatibility. Assess compatibility of the components of a composition by visual inspection of the composition mixture in a glass vial. “Transparent”, or “T”, mixtures indicate complete compatibility. “Hazy”, or “H”, mixtures indicate particle compatibility. “Opaque”, or “O”, mixtures indicate immiscible incompatibility.

Cure Results. Curing assessments are done for each composition after curing 30 minutes and 90 minutes at 80° C. in order to determine the state of curing. A value of “1” is assigned to samples that are “well cured” to a solid piece of material that is visually uniform from top to bottom with hardened surfaces evident from poking the surface with a spatula. A value of “2” is assigned to samples that are “cured but sticky”, which are cured compositions that have a sticky surface. A value of “3” is assigned to samples that have a viscosity increase but are not cured to a solid piece of material. A value of “4” is assigned to samples that remail fluid without significant change of viscosity and are deemed “non-cured” samples.

### Samples and Results

The following Tables 2 and 3 list the components for each sample in grams (hydrosilylation catalyst in weight parts per million weight parts composition) as well as evaluation results for compatibility and curing.

The only compositions in Table 2 that achieve compatibility and full cure even in 80 minutes are compositions that contain only SiH-functional crosslinkers that include phenyl functionality.

Each of the composition in Table 3 demonstrate compatible components and full cure within 80 minutes, with some reaching full cure in only 30 minutes. Each of the compositions in Table 3 use an SiH functional crosslinker that does not contain phenyl functionality and that comprise 90 mole-percent or more of a combination of the following siloxane units: H(R³)₂SiO_{1/2}, SiO_{4/2} and optionally (R³)₃SiO_{1/2} where the average number per molecule of H(R³)₂SiO_{1/2} units is 2 or more, the average number per molecule of SiO₄/2 units is one or more and the average number per molecule of (R³)₃SiO_{1/2} units is such that the number of (R³)₃SiO_{1/2} units divided by the sum of H(R³)₂SiO_{1/2} and (R³)₃SiO_{1/2} units is less than 0.7; where R³ is independently in each occurrence selected from hydrocarbyl groups having from one to 8 carbon atoms. Notably, Table 3 includes compatible compositions that include combinations of such a crosslinker along with crosslinkers that did not achieve compatibility and/or curing from Table 2 but do when blended with crosslinkers from Table 3.

TABLE 2

| | Sample | | | | | | |
|---|---|---|---|---|---|---|---|
| Component | CE1 | CE1 | CE3 | CE4 | CE5 | CE6 | CE7 |
| SiH Crosslinker 1 | 0.2223 | | | | | | |
| SiH Crosslinker 2 | | 0.0863 | | | | | |
| SiH Crosslinker 3 | | | 0.0506 | | | | |
| SiH Crosslinker 4 | | | | 0.132 | | | |
| SiH Crosslinker 5 | | | | | 0.0717 | | |
| SiH Crosslinker 6 | | | | | | 0.0883 | |
| SiH Crosslinker 7 | | | | | | | 0.1286 |
| Polyether 1 | 4 | 4 | 4 | 4 | 4 | 4 | 4 |
| Hydrosilylation | 5 | 5 | 5 | 5 | 5 | 5 | 5 |
| Catalyst 1 (ppm) | | | | | | | |

Characterization

| | | | | | | | |
|---|---|---|---|---|---|---|---|
| Compatibility | H | O | O | T | T | T | T |
| 30 Minute Cure | 4 | 4 | 4 | 3 | 4 | 4 | 2 |
| 80 Minute Cure | 3 | 3 | 3 | 1 | 4 | 4 | 2 |

TABLE 3

| | Sample | | | | | | | | |
|---|---|---|---|---|---|---|---|---|---|
| Component | IE1 | IE1 | IE3 | IE4 | IE5 | IE6 | IE7 | IE8 | IE9 |
| SiH Crosslinker 1 | | | | 0.111 | | | | | |
| SiH Crosslinker 2 | | | | | 0.043 | | | | |
| SiH Crosslinker 3 | | | | | | 0.025 | | | |
| SiH Crosslinker 7 | | | 0.064 | | | | | | |
| SiH Crosslinker 8 | 0.081 | 0.041 | 0.041 | 0.041 | 0.041 | 0.041 | | 0.163 | 0.185 |
| SiH Crosslinker 9 | | | | | | | 0.182 | | |
| Chain Extender 1 | | 0.067 | | | | | | | |
| Polyether 1 | 4 | 4 | 4 | 4 | 4 | 4 | 4 | | |
| Polyether 2 | | | | | | | | 4 | |
| Polyether 3 | | | | | | | | | 5 |
| Hydrosilylation | 5 | 5 | 5 | 5 | 5 | 5 | 5 | 5 | 5 |
| Catalyst 1 (ppm) | | | | | | | | | |

Characterization

| | | | | | | | | | |
|---|---|---|---|---|---|---|---|---|---|
| Compatibility | T | T | T | T | T | H | H | H | T |
| 30 Minute Cure | 1 | 1 | 1 | 1 | 1 | 3 | 3 | 3 | 3 |
| 80 Minute Cure | 1 | 1 | 1 | 1 | 1 | 1 | 1 | 1 | 1 |

What is claimed is:

1. An addition reaction curable polyether composition comprising:
a. a polyether with an average of 1.4 or more unsaturated carbon-carbon bonds per molecule;
b. one or a combination of more than one silyl-hydride functional polysiloxane crosslinker that is free of phenyl groups and that comprises 90 mole-percent or more of a combination of the following siloxane units: H(R³)₂SiO_{1/2}, SiO_{4/2} and optionally (R³)₃SiO_{1/2} where the average number per molecule of H(R³)₂SiO_{1/2} units is 2 or more, the average number per molecule of SiO_{4/2} units is one or more and the average number per molecule of (R³)₃SiO_{1/2} units is such that the number of (R³)₃SiO_{1/2} units divided by the sum of H(R³)₂SiO_{1/2} and (R³)₃SiO_{1/2} units is less than 0.7; where R³ is independently in each occurrence selected from hydrocarbyl groups having from one to 8 carbon atoms; and
c. a hydrosilylation catalyst;
where the molar ratio of SiH/C═C in the addition reaction curable polyether composition is in a range of 0.3 to 10.

2. The addition reaction curable polyether composition of claim 1, wherein the addition reaction curable polyether composition further comprises a chain extender component that contains an average of two silyl-hydride groups per molecule and that is free of SiO_{4/2} siloxane units.

3. The addition reaction curable polyether composition of claim 1, wherein the addition reaction curable polyether composition further comprises a hydrosilylation catalyst inhibitor.

4. The addition reaction curable polyether composition of claim 1, wherein the molar ratio of SiH/C═C in the addition reaction curable polyether composition is in a range of 0.4 to 5.

5. The addition reaction curable polyether composition of claim 1, wherein the unsaturated carbon-carbon bonds of the polyether are part of allyl or methallyl groups.

6. The addition reaction curable polyether composition of claim 1, wherein the polyether is any one or any combination of more than one of the following polyethers:
(i) a tri-branched polypropylene oxide having an average chemical structure (I):
(H₂C═CHCH₂—[OCH₂CH(CH₃)]ₘ—O)₃—R² (I)
the value of m is the average number of propylene oxide units in a given polyether segment and can be the same or different for each of the three polyether segments provided that the value for m is greater than zero in each of the three segments and the average value of the sum of all three m values is 60 or more and at the same time 1000 or less and R² is a trivalent hydrocarbyl group;
(ii) a diallyl end-capped polypropylene oxide having an average chemical structure (II):
{CH₂═CHCH₂O—[CH₂CH(CH₃)O]ₙ}₂—R⁴ (II)
where R⁴ is a divalent hydrocarbyl and subscript n is the average number of propylene oxide units in each of the two polypropylene oxide groups extending off from R⁴ and independently in each occurrence has an average value of 10 or more while at the same time has an average value of 1600 or less; and
(iii) a dimethallyl end-capped polypropylene oxide having an average chemical structure (III):
{CH₂═C(CH₃)CH₂O—[CH₂CH(CH₃)O]ₒ}₂—R⁴ (III)
where R⁴ is a divalent hydrocarbyl and subscript o is the average number of propylene oxide units in each of the two polypropylene oxide groups extending off from R⁴ and independently in each occurrence has an average value of 10 or more while at the same time has an average value of 1600 or less.

7. The addition reaction curable polyether composition of claim 1, wherein the addition reaction curable polyether composition further comprises an additional silyl-hydride functional crosslinker.

8. The addition reaction curable polyether composition of claim 1, wherein the addition reaction curable polyether composition is free of silyl-hydride functional polysiloxane that also has phenyl functionality.

9. The addition reaction curable polyether composition of claim 1, wherein the silyl-hydride functional crosslinker contains on average 5 to 6 SiO_{4/2} units per molecule, 4 to 10 H(R³)₂SiO_{1/2} units per molecule and zero to 5 (R³)₃SiO_{1/2} units per molecule where each R³ is independently in each occurrence selected from hydrocarbyl groups having one to 8 carbon atoms.

10. A process for using the addition reaction curable polyether composition of claim 1, the process comprising disposing the addition reaction curable polyether composition onto another material and then curing the addition reaction curable polyether composition by heating to 80 degrees Celsius or higher.
